(19) United States
(12) Patent Application Publication
(10) Pub. No.: US 2010/0172666 A1
(43) Pub. Date: Jul. 8, 2010

(54) IMAGE FORMING APPARATUS AND CONTROL METHOD THEREOF

(75) Inventor: Chang Seok CHOI, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/652,180

(22) Filed: Jan. 5, 2010

(30) Foreign Application Priority Data
Jan. 7, 2009 (KR) 10-2009-1233

(51) Int. Cl. G03G 15/16

(52) U.S. Cl. 399/66; 399/88

(57) ABSTRACT

Disclosed herein is an image forming apparatus and a control method thereof. According to the control method of the image forming apparatus, entry and exit of a recording medium can be sensed without a register sensor by sensing current change of a press roller used to apply a constant pressure to the recording medium and a transfer belt so as to allow the recording medium and transfer belt to come into close contact with each other. In the case of a model provided with a register sensor, the presence of malfunction of the register sensor can be recognized.

### CROSS-REFERENCE TO RELATED APPLICATIONS

This application claims priority under 35 U.S.C. §119(a) of Korean Patent Application No. 2009-0001233, filed on Jan. 7, 2009 in the Korean Intellectual Property Office, the disclosure of which is incorporated herein by reference.

### BACKGROUND

1. Field of the Invention

The present general inventive concept relates to an image forming apparatus and a control method thereof, and, more particularly, to an image forming apparatus capable of sensing entry and exit of paper using a current change value of a press roller and a control method thereof.

2. Description of the Related Art

A paper supply device of an image forming apparatus includes a feed sensor and register rollers. The feed sensor serves to generate signals indicating whether or not paper is picked up and the beginning of image formation. As paper is picked up and moved upward, a tip end of the paper vibrates based on a curling degree thereof. To reduce deviation at the tip end, a register sensor is used to indicate departure of the paper after the paper is aligned with the feed sensor indicating whether or not the paper is picked up. In operation, the feed sensor determines whether or not paper is picked up, enabling recognition of a paper jam, and the register rollers temporarily stop and align the paper if the tip end of the paper reaches between the register rollers. Thereafter, as the paper is moved via a clutch-on operation, the paper strikes the register sensor when passing the register sensor. On a basis of a time when the register sensor is turned on, a controller commands initiation of image formation. Image formation is stopped when the register sensor is turned off.

Conventionally, in the case where recognition of entry and exit of paper depends on the register sensor, paper vibration may cause the image forming apparatus to experience a paper jam, or image omission during printing.

### SUMMARY

Therefore, it is an exemplary embodiment of the present general inventive concept to provide an image forming apparatus capable of sensing entry or exit of a recording medium into or from a press roller by sensing a current change of the press roller that is used to make the recording medium come into close contact with a transfer belt, and a control method of the image forming apparatus.

Additional features and utilities will be set forth in part in the description which follows and, in part, will be obvious from the description, or may be learned by practice of the invention.

In accordance with an exemplary embodiment of the present general inventive concept, the above and/or other features and utilities can be achieved by the provision of an image forming apparatus including a press roller to press a recording medium against a transfer belt, a power supply part to apply power to the press roller, a current sensing part to sense a current value of the press roller, and a control part to determine at least one of entry and exit of the recording medium to and from the press roller based on a current value sensed via the current sensing part.

In accordance with another exemplary embodiment of the present general inventive concept, there is provided an image forming apparatus including, a press roller to press a recording medium against a transfer belt, a register sensor provided between the press roller and a register roller and used to sense the recording medium discharged from the register roller, a power supply part to apply power to the press roller, a current sensing part to sense a current value of the press roller, and a control part to determine exit of the recording medium if the current value sensed via the current sensing part is equal to a preset value corresponding to exit of the recording medium when the register sensor senses the recording medium discharged from the register sensor.

In accordance with another exemplary embodiment of the present general inventive concept, there is provided a control method of an image forming apparatus including applying power to a press roller used to press a recording medium against a transfer belt, sensing a current value of the press roller, and determining entry or exit of the recording medium into or from the press roller based on the sensed current value.

Embodiments of the present general inventive concept also provide a printer, comprising a press roller to apply a constant pressure to a recording medium and transfer belt against a driven roller, a power supply part to apply power to the press roller, an electrical resistance sensing part to monitor electrical resistance of the press roller; and a control part to establish whether the recording medium has entered or exited a nip region between the press roller and driven roller based on an electrical resistance value sensed by the electrical resistance sensing part.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a schematic configuration view of an image forming apparatus in accordance with an exemplary embodiment of the present general inventive concept;

FIG. 2 is a functional block diagram of the image forming apparatus in accordance with an exemplary embodiment of the present general inventive concept;

FIG. 3 is a timing chart illustrating an operation to sense entry and exit of paper based on current change of a press roller by a control part illustrated in FIG. 2;

FIG. 4 is another functional block diagram of the image forming apparatus in accordance with an exemplary embodiment of the present general inventive concept;

FIG. 5 is a timing chart illustrating an operation to determine malfunction of a register sensor based on current change of a press roller by a control part illustrated in FIG. 2; and

FIG. 6 is a control flow chart of the image forming apparatus in accordance with an exemplary embodiment of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to like elements throughout. The exemplary embodiments are described below to explain the present general inventive concept by referring to the figures.

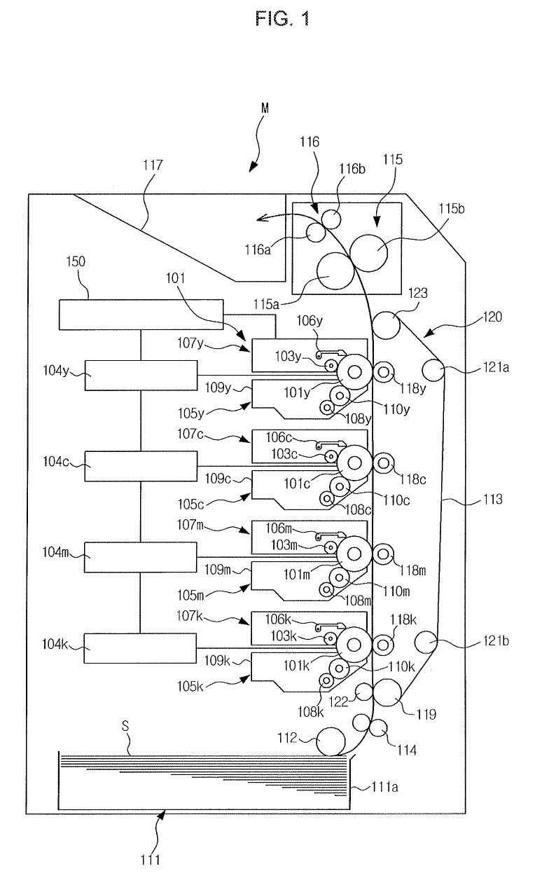

FIG. 1 schematically illustrates a configuration of a color image forming apparatus in accordance with an exemplary embodiment of the present general inventive concept. As illustrated in FIG. 1, the color image forming apparatus in accordance with an exemplary embodiment of the present general inventive concept may include a paper supply unit 111, an image forming unit 101, a transfer unit 120, a fixing unit 115, a paper discharge unit 116, and a control part 150.

The paper supply unit 111 may serve to supply recording media S, such as paper. The paper supply unit 111 may include a paper supply cassette 111a, a pickup roller 112, and register rollers 114. The paper supply cassette 111a may be mounted on the bottom of an apparatus body M. The recording media S, loaded in the paper supply cassette 111a, may be picked up by the pickup roller 112 sheet by sheet and delivered to the register rollers 114.

The image forming unit 101 may be arranged above the paper supply unit 111 and may serve to form developer images of desired colors, i.e. black (K), magenta (M), cyan (C), and yellow (Y) developer images on the recording medium S.

The image forming unit 101 may include first, second, third, and fourth photoconductors 101k, 101m, 101c, and 101y. The first, second, third, and fourth photoconductors 101k, 101m, 101c, and 101y may be arranged vertically from the bottom to the top of FIG. 1 with a predetermined distance therebetween, so as to be opposite a transfer belt 113 of the transfer unit 120 which will be described hereinafter. Specifically, the first, second, third, and fourth photoconductors 101k, 101m, 101c and 101y may come into contact with the transfer belt 113 at a constant pressure to individually define a nip region therebetween by first, second, third, and fourth transfer rollers 118k, 118m, 118c, and 118y, of the transfer unit 120 which will be described hereinafter. These photoconductors 101k, 101m, 101c, and 101y may be rotated counterclockwise by a gear train as power from a drive motor (not illustrated) may be transmitted to the gear train.

Provided respectively around the first, second, third, and fourth photoconductors 101k, 101m, 101c, and 101y may be first, second, third, and fourth charging devices 103k, 103m, 103c, and 103y, respectively, first, second, third, and fourth laser scanning devices 104k, 104m, 104c, and 104y, respectively, first, second, third, and fourth developing devices 105k, 105m, 105c, and 105y, respectively, and first, second, third, and fourth charge eliminating devices 102k, 102m, 102c, and 102y, respectively.

The first, second, third, and fourth charging devices 103k, 103m, 103c, and 103y may take the form of conductive rollers. The first, second, third, and fourth charging devices 103k, 103m, 103c, and 103y may come into contact with surfaces of the first, second, third, and fourth photoconductors 101k, 101m, 101c, and 101y, respectively. If a predetermined charging bias voltage is usable from a power supply part to the first, second, third, and fourth charging devices 103k, 103m, 103c, and 103y under control of the control part 150, the first, second, third, and fourth charging devices 103k, 103m, 103c, and 103y may charge the surfaces of the first, second, third, and fourth photoconductors 101k, 101m, 101c, and 101y with a predetermined charging electric potential, for example, a charging electric potential of about −600V when a developer has a negative polarity.

The first, second, third, and fourth laser scanning devices 104k, 104m, 104c, and 104y may irradiate laser beams, based on image signals input from a computer, scanner, etc., to the surfaces of the first, second, third, and fourth photoconductors 101k, 101 m, 101c, and 101y, respectively, charged by the first, second, third, and fourth charging devices 103k, 103m, 103c, and 103y, respectively, thereby forming electrostatic latent images having a predetermined electric potential lower than the charging electric potential, for example, a low electric potential of about −50V. The configuration of the first, second, third, and fourth laser scanning devices 104k, 104m, 104c, and 104y may be identical to a generally known configuration and thus, a detailed description thereof will be omitted.

The first, second, third, and fourth developing devices 105k, 105m, 105c, and 105y may attach developers of corresponding colors to the surfaces of the first, second, third, and fourth photoconductors 101k, 101m, 101c, and 101y on which the electrostatic latent images are formed, so as to develop the electrostatic latent images into visible developer images. The first, second, third, and fourth developing devices 105k, 105m, 105c, and 105y, respectively may include first, second, third, and fourth developer receptacles 109k, 109m, 109c, and 109y, first, second, third, and fourth developing rollers 110k, 110m, 110c, and 110y, and first, second, third, and fourth developer supply rollers 108k, 108m, 108c, and 108y.

The first, second, third, and fourth developer receptacles 109k, 109m, 109c, and 109y respectively may receive black (K), yellow (Y), magenta (M), and cyan (C) developers of a predetermined polarity, for example, a negative polarity.

The first, second, third, and fourth developing rollers 110k, 110m, 110c, and 110y may rotatably engage with the first, second, third, and fourth photoconductors 101k, 101 m, 101c, and 101y, to develop the electrostatic latent images on the first, second, third, and fourth photoconductors 101k, 101m, 101c, and 109y via attachment of the developers. The first, second, third, and fourth developing rollers 110k, 110m, 110c, and 110y, may be arranged close to the surfaces of the first, second, third, and fourth photoconductors 101k, 101m, 101c, and 101y, and may be rotated clockwise by a power transmission gear connected to the gear train that is used to rotate the photoconductors 101k, 101 m, 101c, and 101y. A predetermined developing bias voltage may be usable from the power supply part to the first, second, third, and fourth developing rollers 110k, 110m, 110c, and 110y under control of the control part 150. The predetermined developing bias voltage may be lower than a voltage usable with to the first, second, third, and fourth developer supply rollers 108k, 108m, 108c, and 108y by 100˜400V, and may be, for example, about −250V.

The first, second, third, and fourth developer supply rollers 108k, 108m, 108c, and 108y may supply the developers to the first, second, third, and fourth developing rollers 110k, 110m, 110c, and 110y by use of an electric potential difference with the first, second, third, and fourth developing rollers 110k, 110m, 110c, and 110y. The first, second, third, and fourth developer supply rollers 108k, 108m, 108c, and 108y may be arranged to come into contact with lateral lower parts of the first, second, third, and fourth developing rollers 110k, 110m, 110c, and 110y, to individually define a nip region therebetween. The black (K), yellow (Y), magenta (M), and cyan (C) developers may be delivered in the first, second, third, and fourth developer receptacles 109k, 109m, 109c, and 109y by agitators to spaces underneath and between the first, second, third, and fourth developer supply rollers 108k, 108m, 108c, and 108y and the first, second, third, and fourth developing rollers 110k, 110m, 110c, and 110y.

A predetermined developer supply bias voltage may be usable from the power supply part to the first, second, third, and fourth developer supply rollers 108k, 108m, 108c, and 108y under control of the control part 150. The predetermined developer supply bias voltage may be higher than the developing bias voltage applied to the first, second, third, and fourth developing rollers 110k, 110m, 110c, and 110y by 100˜400V, and may be, for example, −500V. Accordingly, once the developers are delivered to the spaces underneath and between the first, second, third, and fourth developer supply rollers 108k, 108m, 108c, and 108y and the first, second, third, and fourth developing rollers 110k, 110m, 110c, and 110y, the developers may be are changed by the first, second, third and fourth developer supply rollers 108k, 108m, 108c, and 108y, thereby attaching to the first, second, third, and fourth developing rollers 110k, 110m, 110c, and 110y having a relatively low electric potential. In this manner, the developers may be moved to the nip regions between the first, second, third, and fourth developer supply rollers 108k, 108m, 108c, and 108y and the first, second, third, and fourth developing rollers 110k, 110m, 110c, and 110y.

First, second, third, and fourth cleaning devices 107k, 107m, 107c, and 107y may be provided to remove waste developer remaining on the surfaces of the first, second, third, and fourth photoconductors 101k, 101m, 101c, and 101y after one cycle rotation of the first, second, third, and fourth photoconductors 101k, 101m, 101c, and 101y. The first, second, third, and fourth cleaning devices 107k, 107m, 107c, and 107y respectively may include first, second, third, and fourth photoconductor cleaning blades 106k, 106m, 106c, and 106y.

The transfer unit 120 may serve to transfer the developer images formed on the first, second, third and fourth photoconductors 101k, 101m, 101c, and 101y to the recording medium S. The transfer unit 120 may include the transfer belt 113 and first, second, third, and fourth transfer rollers 118k, 118m, 118c, and 118y.

The transfer belt 113 may serve to deliver the recording medium S, and may be rotated in a medium delivery direction (as represented by the arrow A in FIG. 1) by a plurality of rotating rollers including a driving roller 123, first and second tension rollers 121a and 121b and a driven roller 119 arranged in sequence from the downstream of the medium delivery direction (i.e. from the upper part of FIG. 1).

A surface of the transfer belt 113 may be coated with an organic photoconductive layer, to enable the developer images formed on the first, second, third, and fourth photoconductors 101k, 101m, 101c, and 101y to be transferred to the transfer belt 113.

The first, second, third, and fourth transfer rollers 118k, 118m, 118c, and 118y may be transfer voltage applying members to apply a predetermined transfer bias voltage to the transfer belt 113. The first, second, third, and fourth transfer rollers 118k, 118m, 118c, and 118y may be arranged inside the transfer belt 113 to respectively press the transfer belt 113 by a constant pressure against the first, second, third, and fourth photoconductors 101k, 101 m, 101c, and 101y. The predetermined transfer bias voltage may be usable from the power supply part to the first, second, third, and fourth transfer rollers 118k, 118m, 118c, and 118y under control of the control part 150.

The fixing unit 115 may serve to fix the developer images transferred to the recording medium S. The fixing unit 115 may include a heating roller 115a and a pressurizing roller 115b. The heating roller 115a may contain a heater therein to fix the developer images to the recording medium S using high-temperature heat.

The pressurizing roller 115b may be pressed against the heating roller 115a via an elastic pressurizing member, to pressurize the recording medium S.

The paper discharge unit 116 may serve to discharge the recording medium S, on which the developer images may be fixed, into a discharge tray 117. The paper discharge unit 116 may include a paper discharge roller 116a and a backup roller 116b.

A press roller 122 may be arranged at the most upstream of the medium delivery direction (i.e. at the lower part of FIG. 1) and may be used to press the transfer belt 113 against the driven roller 119. The press roller 122 may serve to apply a constant pressure to the recording medium S and transfer belt 113, so as to allow the transfer belt 113 and recording medium S to come into close contact with each other. For example, a predetermined voltage of about 300˜500V may be usable from the power supply part to the press roller 122 under control of the control part 150. With the press roller 122, the recording medium S, delivered to the transfer belt 113 by the register rollers 114, may be able to be adsorbed to and delivered by the transfer belt 113. The press roller 122 also may serve to determine a transfer voltage of the first, second, third, and fourth transfer rollers 118k, 118m, 118c, and 118y based on a load of the recording medium S. For this, a current change may be determined from a load change based on a thickness of the recording medium S between the press roller 122 and the transfer belt 113 and an environmental temperature.

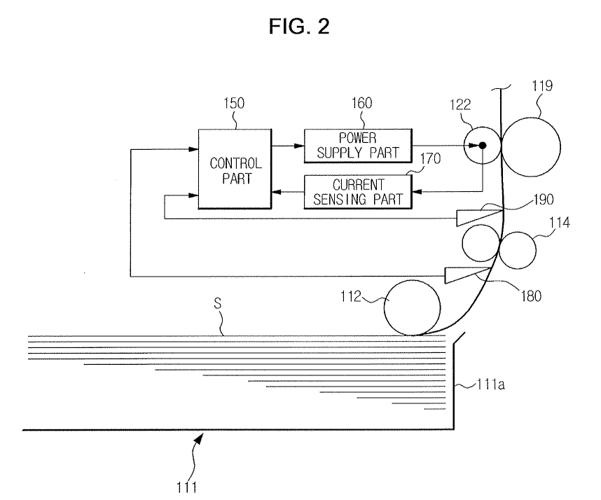

FIG. 2 is a functional block diagram of the image forming apparatus in accordance with an exemplary embodiment of the present general inventive concept. As shown in FIG. 2, there may be provided the control part 150, power supply part 160, current sensing part 170, feed sensor 180, register sensor 190, etc.

The power supply part 160 may apply a constant voltage to the press roller 122 to apply a constant pressure to the recording medium S and transfer belt 113, in order to allow the transfer belt 113 and recording medium S to come into close contact with each other well.

The current sensing part 170 may sense a current value of the press roller 122.

The control part 150 may read and may store a current value sensed via the current sensing part 170, and may determine, based on change in current value, whether or not the recording medium S enters or exits the press roller 122. It is noted that, instead of monitoring change in current value, monitoring a change in an electric characteristic value, such as voltage or resistance, that may be changed as the recording medium S enters or exits the press roller 122, can accomplish the same result. Since the recording medium acts as a resistor, it will be appreciated that a current value in a state wherein the recording medium is engaged with the press roller 122 differs from a current value in a state wherein the recording medium is not being engaged with the press roller 122. Accordingly, based on this principle, an exemplary embodiment of the present general inventive concept may sense the entry or exit of the recording medium into or from the press roller 122. The current voltage may increase when the recording medium enters to the press roller 122, and may decrease when the recording medium exits the press roller 122. Accordingly, if the current value is increased as a result of comparing the current values before and after the recording medium enters the press roller 122, it can be determined that the recording medium enters the press roller 122. On the contrary, if the current value is decreased, it can be determined that the recording medium exits the press roller 122.

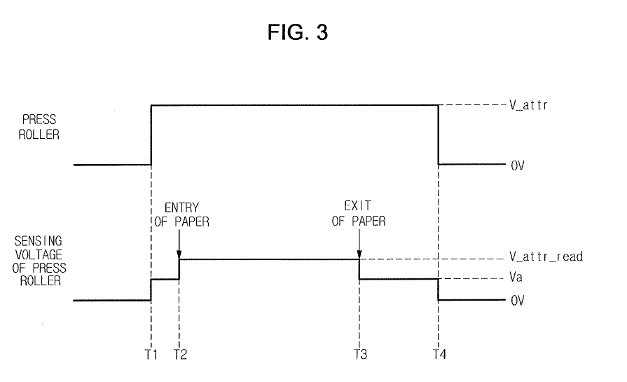

As illustrated in FIG. 3, if a voltage V_attr of about 300˜500V is usable with the press roller 122 in order to cause paper, as the recording medium, to come into close contact with the transfer belt 113 at a time T1, a sensing voltage of the press roller 122 to be input into the control part 150 may be raised from a voltage OV to a voltage Va. If the paper enters the press roller 122 at a time T2, a current value of the press roller 122 may be changed based on change in load, causing the sensing voltage of the press roller 122 to be input into the control part 150 to be raised from the voltage Va to a voltage V_attr_read. Thereby, the control part 150 may recognize entry of the paper into the press roller 122 based on change in sensing voltage corresponding to change in the current change of the press roller 122.

On the other hand, if the paper exits the press roller 122 at a time T3, the current value of the press roller 122 may be changed based on change in load, causing the sensing voltage of the press roller 122 to be input into the control part 150 to be lowered from the voltage V_attr_read to the voltage Va. Thereby, the control part 150 may recognize exit of the paper from the press roller 122 based on change in sensing voltage corresponding to change in the current value of the press roller 122.

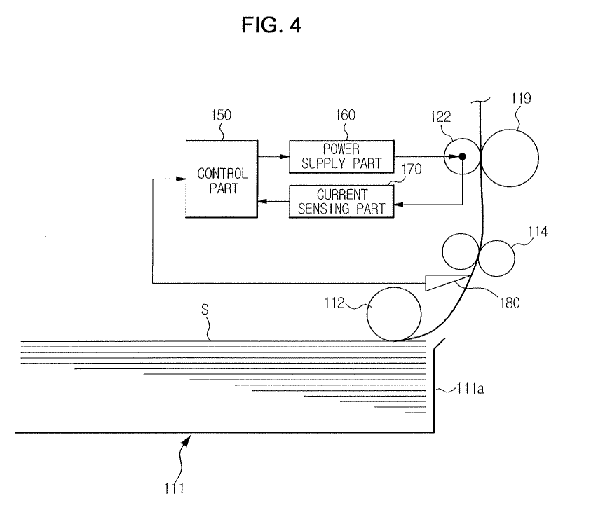

FIG. 4 is another functional block diagram of the image forming apparatus in accordance with an exemplary embodiment of the present general inventive concept. As shown in FIG. 4, the image forming apparatus in accordance with an exemplary embodiment of the present general inventive concept may have no register sensor, so that the control part functions as the register sensor using the current change of the press roller.

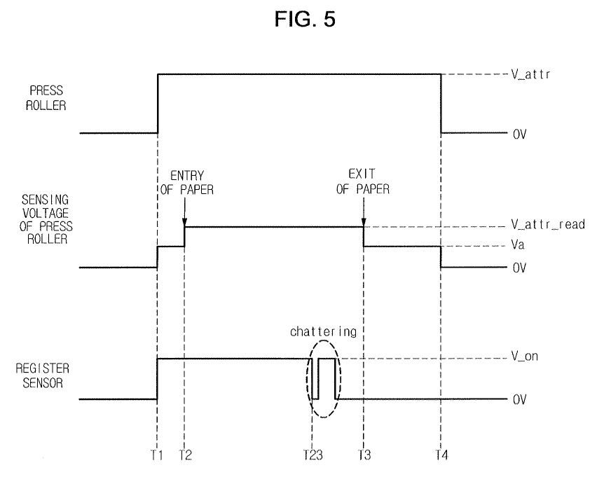

As illustrated in FIG. 5, if the register sensor 190 is turned on, the control part 150 may determine entry of paper. It is noted that, when the register sensor 190 is temporarily turned off by, for example, paper vibration, the control part 150 may directly recognize exit of paper, but may recognize exit of paper only when a checked sensing voltage of the press roller 122 is lowered from the voltage V_attr_read to the voltage Va. Thereby, recognition of malfunction of the register sensor 190 due to paper vibration may be possible.

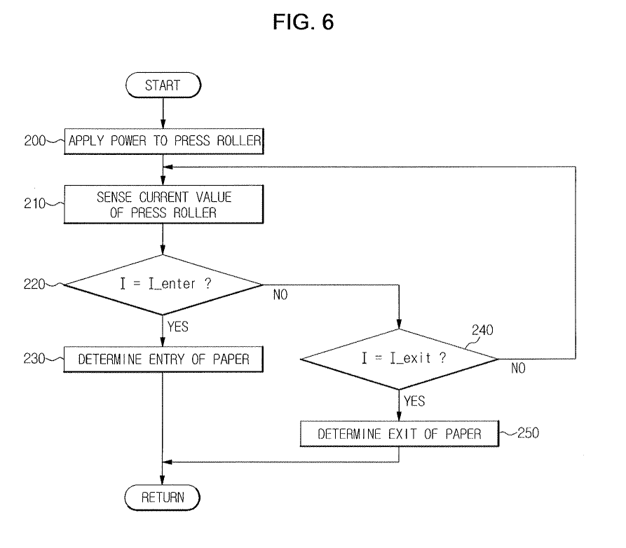

FIG. 6 illustrates a control method of the image forming apparatus in accordance with an exemplary embodiment of the present general inventive concept. Referring to FIG. 6, the control part 150 first may command the power supply part 160 to apply a power of about 300˜500V to the press roller 122, so as to allow paper to come into close contact with the transfer belt 113 (operation, 200). After applying the power to the press roller 122, the control part 150 may command the current sensing part 170 to sense a current value of the press roller 122 (operation, 210).

After sensing the current value of the press roller 122, the control part 150 may compare the sensed current value I with a preset value I_enter corresponding to entry of paper, may determine whether or not the sensed current value I is equal to the preset value I_enter (operation, 220). If the determined result at the operating mode 220 indicates that the sensed current value I is equal to the present value I_enter corresponding to entry of paper, the control part 150 may determine that paper enters the press roller 122 (operation, 230). If entry of paper is confirmed, the control part 150 may command initiation of image formation based on the confirmed result.

On the other hand, if the determined result at the operating mode 220 indicates that the sensed current value I is not equal to the preset value I_enter corresponding to entry of paper, the control part 150 may determine that the sensed current value I is equal to a preset value I_exit corresponding to exit of paper (operation, 240). If the sensed current value I is not equal to the preset value I_exit corresponding to exit of paper, the control method may be returned to the operating mode 210, carrying out subsequent operating modes.

If the determined result at the operating mode 240 indicates that the sensed current value I is equal to the preset value I_exit corresponding to exit of paper, the control part 150 may determine that paper exits the press roller 122.

As is apparent from the above description, according to an exemplary embodiment of the present general inventive concept, entry and exit of a recording medium can be sensed without a register sensor by sensing current change of a press roller used to apply a constant pressure to the recording medium and a transfer belt so as to allow the recording medium and transfer belt to come into close contact with each other well. If an exemplary embodiment of the present general inventive concept is usable with to a model provided with a register sensor, malfunction of the register sensor can be recognized.

Although a few embodiments of the present general inventive concept have been illustrated and described, it would be appreciated by those skilled in the art that changes may be made in these exemplary embodiments without departing from the principles and spirit of the general inventive concept, the scope of which is defined in the claims and their equivalents.

What is claimed is:

1. An image forming apparatus comprising:
a press roller to press a recording medium against a transfer belt;
a power supply part to apply power to the press roller;
a current sensing part to sense a current value of the press roller; and
a control part to determine at least one of entry and exit of the recording medium to and from the press roller based on a current value sensed via the current sensing part.

2. The image forming apparatus according to claim 1, wherein, if the sensed current value is equal to a preset value corresponding to entry of the recording medium, the control part determines that the recording medium enters the press roller.

3. The image forming apparatus according to claim 1, wherein, if the sensed current value is equal to a preset value corresponding to exit of the recording medium, the control part determines that the recording medium exits the press roller.

4. An image forming apparatus, comprising:
a press roller to press a recording medium against a transfer belt;
a register sensor provided between the press roller and a register roller and used to sense the recording medium discharged from the register roller;
a power supply part to apply power to the press roller;
a current sensing part to sense a current value of the press roller; and
a control part to determine the exit of the recording medium if the current value sensed via the current sensing part is equal to a preset value corresponding to exit of the recording medium when the register sensor senses the recording medium discharged from the register sensor.

5. A control method of an image forming apparatus, comprising:
applying power to a press roller used to press a recording medium against a transfer belt;
sensing a current value of the press roller; and
determining entry or exit of the recording medium into or from the press roller based on the sensed current value.

6. The control method according to claim 5, wherein, if the sensed current value is equal to a preset value corresponding to entry of the recording medium, it is determined that the recording medium enters the press roller.

7. The control method according to claim 5, wherein, if the sensed current value is equal to a preset value corresponding to exit of the recording medium, it is determined that the recording medium exits the press roller.

8. An image forming apparatus, comprising:
a press roller to apply a constant pressure to a recording medium and transfer belt against a driven roller;
a power supply part to apply power to the press roller;
an electrical resistance sensing part to monitor electrical resistance of the press roller; and
a control part to establish whether the recording medium has entered or exited a nip region between the press roller and driven roller based on an electrical resistance value sensed by the electrical resistance sensing part.

9. The image forming apparatus according to claim 8, wherein, if the electrical resistance value is equal to a preset value corresponding to entry of the recording medium, the control part determines that the recording medium enters the press roller.
